(19) United States
(12) Patent Application Publication
(10) Pub. No.: US 2008/0293413 A1
(43) Pub. Date: Nov. 27, 2008

(54) System and Method of Registering with an Access Point

(75) Inventors: Seyed M. Sharif-Ahmadi, Richmond (CA); Fay Arjomandi, Richmond (CA)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: MOBIDIA, INC., Richmond, British Columbia (CA)

(21) Appl. No.: 11/916,809

(22) PCT Filed: Jun. 6, 2006
(86) PCT No.: PCT/CA2006/000902

§ 371 Date: Jun. 25, 2008

(30) Foreign Application Priority Data
Jun. 6, 2005 (US) 60687339

(51) Int. Cl. H04Q 7/20

(52) U.S. Cl. 455/435.1; 455/432.1

(57) ABSTRACT

A method of registering a mobile device with an access point, is provided in which the mobile device preregisters with access points nearby in order to accelerate the registration process when roaming is initiated. Roaming may be initiated when the SNR is increasing relative to the current access point and decreasing relative to another access point.

This application claims the benefit of U.S. provisional application No. 60/687,339, filed on Jun. 6, 2005.

### FIELD OF THE INVENTION

This invention relates to systems and methods of managing data traffic over networks, and more particularly to systems and methods for addressing the diverse requirements of different data types and their behaviour over different types of wired and wireless networks, each such network having different characteristics and changing network status.

### BACKGROUND OF THE INVENTION

Wireless networks generally have very different properties when compared to traditional wired networks. For example, the “backbone” of a wired network is more homogeneous than a wireless network, and a wired network is typically, a mesh of intelligent sub networks connected through routers and switches that control data traffic. In wired networks, users are generally stationary and therefore movement of users has little impact on network service. The key influence on user service in a wired network is the data traffic congestion on the network. This congestion problem is dealt with by using the Transmission Control Protocol/Internet Protocol (TCP/IP), a communications protocol that most network applications use.

Wireless network characteristics and implementations are quite different from wired networks, for example, in the following ways:

1. The network infrastructure of a wireless network is simpler, with respect to the number of nodes between a mobile networked device and a first wired link in the network.

2. The status of a wireless network changes frequently, due to several factors, including: environmental conditions (e.g. downtown urban area vs. suburban area with different signal attenuation and propagation); mobile device location (e.g. close to a large power supply field vs. in a large open area); network traffic at a given time, adjacent user usage of the network; and the base station backbone (e.g. fiber vs. copper backbone).

3. Software applications are generally not designed for wireless network environments that include frequent status variation. Therefore, operating such applications over a wireless network may worsen the network status by adding additional traffic, and thereby increasing the overall delay and latency of the network, which, in turn, may impact the experiences of other mobile device users.

Two parallel changes occurring in wireless network technologies are: i) the introduction of new wireless network types, so that the overall wireless network infrastructure is changing from being a single type network, for example a General Packet Radio Service (GPRS) network only, to an infrastructure comprising multiple network types, such as GPRS, Wi-Fi, Worldwide Interoperability for Microwave Access (WiMAX) and Universal Mobile Telecommunications System (UMTS); and, ii) wireless network users are no longer only using “background class” type of applications such as email, short message services (SMS) and downloads, but are now using more interactive applications such as web browsing, network gaming, and database access; streaming applications such as multimedia applications, video on demand, and webcasting; and conversational applications such as Voice over Internet Protocol (VoIP), video telephony, and video gaming. Service providers, or carriers, are driving to increase the usage of these applications over wireless networks as to increase “average revenue per user” and subscription rates. The service providers also differentiate themselves from competitors through the services offered along with Quality of Service (QoS) for their own “certified” applications as compared to third party applications. However, use of these different types of applications results in different data traffic types traversing the network, each data type having different delivery (time) requirements and different error tolerances (in time sensitive vs. error sensitive spectrums of applications). For example, a VoIP packet is very time sensitive and has a short time to live, whereas a data packet is very error sensitive. TCP and UDP/IP protocols (widely used by many software applications) are both network and application agnostic. TCP does provide congestion control features which occur on wired networks but the protocol doesn't distinguish a wired network from a wireless network. Also neither of these protocols are application aware (they are not sensitive to the type of applications and time vs. error sensitivity). TCP/IP has been designed specifically to overcome the congestion problems in wired networks by detecting the congestion on the network and controlling the traffic between the two communicating parties. However, use of TCP/IP over wireless networks may be problematic. For example, delays in the wireless network may be caused by signal attenuation (not by congestion), causing TCP/IP to actually reduce performance of a wireless network.

Therefore, what is lacking in the prior art is the awareness and involvement of the networked (for example, mobile) device in the network by enabling the networked device to act as an intelligent and integrated element (similar to a router/switch) within the network. In the prior art, the networked device, particularly mobile devices, lack the ability to make decisions based on the types of wired or wireless network(s) available to it and the types of data it is communicating to other networked devices (given the differences between wireless and wired networks, data communications should be treated differently over the two network types).

The prior art fails to address the following problems:

1. TCP/IP inefficiency over wireless networks;
2. the lack of knowledge of wireless networks within the protocol layer of networked devices;
3. VoIP and the standard streaming video control protocol, known as the Real-Time Transport Control Protocol (RTCP) inefficiency over wireless networks;
4. the inability to dynamically distinguish between the different types of data and meet their real-time requirements in a mixed network, without relying on IP header information;
5. the inability of a mobile device in a mixed network to be aware of the types of the available networks and the status of each network at any given time and to feedback status information to the network as part of the data protocol delivery without requiring any extra transaction;
6. the inability of a mobile device in a mixed network to predict the signal to noise ratio (SNR), outside the physical layer and below the IP layer, of the wireless network and to make decisions for appropriate traffic types, such as forwarding/redirecting traffic through different networks, or using two types of networks simultaneously based on their conditions and network policy;
7. the inability to provide local jitter handling within a mobile device in the layer below IP; and
8. the inability to provide mobile data traffic prioritization, queuing and scheduling within a mobile device, based on the network condition and policy, or through either DNA/fingerprints set by a catalogue ID or determining the application type.

There have been attempts to solve one of the issues listed above, specifically TCP/IP inefficiency over wireless networks. These solutions include using TCP/IP spoofing and tunnelling techniques that are inefficient and often cause yet more unnecessary data to be sent over the wireless networks, and produce extra processing overhead for the network device.

TCP/IP is a protocol designed for wired networks and is well suited for problems in that environment, which are usually congestion related. If a node in a network using TCP/IP does not receive an acknowledgment, the node concludes there is congestion in the network and tries to help the network by slowing down transmissions and providing flow control. In a wireless network, the failure to receive an acknowledgment within a given time is usually not due to congestion but due to instant network delays, signal strength drop, or latency variation. In such situations a TCP/IP node will slow down the transmission and take some time before returning to its normal speed of operation. During this time the throughput over the same bandwidth will be reduced because of the unnecessarily slowed transmission.

Another problem caused by TCP/IP is that it was designed for the low bit error rate link environment of a wired network and therefore if one packet within a stream of packets is lost then all packets are resent. For example, if a single packet is lost within a 20 packet stream the network node will resend all packets in the stream, even if most were successfully received.

Some application level protocols such as HyperText Transfer Protocol (HTTP) use TCP/IP in a manner that is not wireless network friendly. For example, when a HTTP browser, such as Microsoft Explorer, makes a communications request, the HTTP browser performs two or three simultaneous TCP/IP calls. Each TCP/IP call requires three-way handshaking (three requests and responses) to establish the link. Over wireless links (that normally have a higher latency than wired links), if a response does not arrive on time this will be interpreted as a need for a new TCP/IP request. If one TCP/IP link is delayed the browser will request another TCP/IP link with another three-way handshake. All of these communications create extra overhead and add delay to a wireless network.

To solve these problems there have been several inefficient solutions, which focus on a single type of data, using applications such as Internet Explorer. Following are the approaches taken to overcome TCP/IP inefficiency over the wireless networks:

1. Compression of data (content) which reduces the amount of data going over the network;
2. Domain Name System (“DNS”) caching within a mobile device; and
3. User Datagram (“UDP”) tunnelling of compressed TCP/IP packets, and TCP/IP spoofing.

To date, none of these approaches have been entirely adequate. The shortcomings of each of these approaches are as follows:

### 1. Content Compression

Content compression is typically applied only to “background” applications and to some interactive applications, such as Internet Explorer requesting a website which includes both text and picture objects. This method compresses content based on the classification of the data as lossy or lossless, e.g. Joint Photographic Expert Group (“JPEG”) and text (“txt”) file formats. These classifications allow for compression in different ways and ratios. Although this method reduces the amount of data travelling over the network, which indirectly results in greater use of bandwidth, it does not eliminate TCP/IP inefficiencies over wireless networks, as it is the wireless delay variations that cause the strange behaviour of TCP/IP.

### 2. DNS Caching Within a Mobile Device

DNS caching within a mobile device is used to reduce the time required for DNS searches. This technique requires software within the mobile device to cache the results from the DNS for each DNS query. The next time the same query is requested the DNS cache is used to provide the result instead of transmitting the request over the network and waiting for the response. This technique reduces the need for transferring frequently requested queries but it does not address TCP/IP inefficiency directly.

### 3. Tunnelling

Tunnelling includes UDP tunnelling of either compressed or uncompressed TCP/IP data. Tunnelling requires software within both the mobile device and the server communicating to capture the TCP/IP data and tunnel the entire TCP packet through UDP. The disadvantages of this technique include:
(i) Process consumption. As TCP data has already been created and passed to a lower layer, the network node should pass the data back to a higher layer, user-mode, proxy type application, which sends the TCP packet back to the protocol layer, in kernel-mode, but requests a UDP packet this time (called a UDP tunnel). If the network node is using IP Security (IPSec) Virtual Private Network (VPN) encryption security the tunnelled TCP data will go through yet another IPSec tunnel. This means that more processing time will be required for a small mobile device and further delays will be caused by the tunnelling technique. Also, if the compression or encryption happened in the layer 4 (above TCP and UDP layers and below the application layer) then the proxy-type may not be able to distinguish the type of application.
(ii) Increased network traffic. Tunnelling within tunnelling (as described above) increases traffic over the network. This “solution” does not solve the TCP inefficiency issues created by the wireless network's latency variation, as TCP data has already been created but is wrapped around a different protocol for transmission. The main reason to tunnel TCP data is to compress the data, so therefore the data is wrapped around another protocol for transmission. However, if the network has high latency, TCP would still result in strange behaviour due to lack of receiving responses in a timely fashion.

In order to overcome TCP problems over wireless and mixed networks some solutions involve transferring extra packets, such as ping or extra acknowledgments to maintain proper TCP behaviour over the wireless link and to keep the link “alive” for the software application. This approach also increases the traffic over the wireless network by adding unnecessary data and also changes the mechanism of new packet switched networks to that of the old legacy circuit switch networks. The philosophy of a packet switched network is to allocate the link to a mobile user only when there is data available to transmit. During the time the user is waiting for a response the uplink will be allocated to another mobile user. This results in higher network capacity and enables use of the existing network for larger numbers of network users. Circuit switched networks have the link allocated to the mobile device user for a certain period of the time, whether or not the mobile user has any data available to transmit. During this time other mobile device users wait for the link to be de-allocated from that mobile device user and re-allocated to them by the network. This results in a lower network capacity and inefficient use of the network.

### Roaming

Roaming is the process of moving from one access point (“AP”) to another over a wireless link, for example, a mobile device user moving in an airport. For connection-oriented applications (for example, those that are TCP/IP based) the latency to transfer the communications and connection from one AP to another could result in the retransmission of data and reestablishment of TCP after receiving a new IP from a new domain (in case of an intra domain move). For time-sensitive applications, this results in additional delay caused by the movement from one AP or domain to another.

There are two current preferred methods of dealing with this issue:

1. Pre-emptive AP discovery, in which the mobile device scans the networks available, to check for the strengths of available APs, before a decision to roam is made; and roam-time AP discovery, in which the mobile device makes a decision to roam and then scans the area to find an alternative AP. This method is vendor specific and is not based on any particular standard.

2. The client may initiate roam, which is well defined in various standards and thereby the client resumes the application session.

A problem in the art is in resuming an application session and this has not been specified in any standard. It has been suggested that the Mobile IP standard within a network could solve the problem, but the amount of signalling traffic within Mobile IP creates too much unnecessary traffic.

### BRIEF SUMMARY OF THE INVENTION

The system and method according to the invention comprises a software platform that provides mixed mobile data traffic management over wired, wireless, or mixed networks. The system and method addresses the diverse requirements of different data types and their behaviour over different wireless networks, each network having different characteristics and changing network status. A mobile device is incorporated as part of the overall network instead of treated as an independent entity outside the network. In the prior art, the mobile node (i.e. the mobile device) is an independent entity, disjoint from the network, blind to the types of network(s) available, and blind to the different types of data it is communicating with other networked devices. The present invention provides a comprehensive software solution that incorporates the mobile node as part of the network, enabling it to be an active participant within the network, and enabling it to manage and negotiate specific data needs with the network components.

The system and method according to the invention makes the mobile device aware of the network situation and application types and therefore their requirements; and also is aware of network policies at any given time, and therefore can make efficient decisions. The necessary “intelligence” is available so that there is no need to alter “any” application, the mobile device's Operating System (OS) code structure, or hardware. The solution is such that the network works with or without the system according to the invention (but the network is more efficient with such system) and other mobile devices not using the system can operate within the network. This is accomplished by adding the capability to the mobile device's OS to intercept system calls and alter the calls without initiator and destination involvement.

To implement these capability two layers are inserted within the mobile device's kernel OS to intercept the application path. A first layer receives the application calls, identifies the types of application and data; builds a protocol; and redirects to the UDP (if it was for TCP). The second layer controls the physical layer, so that the second layer monitors the status of the networks, predicts the status of the networks in the near future, schedules the outgoing traffic types based on this information, provides local jitter handling for received packets for conversational class of applications, and provides the collected status to the other layers. The second layer also provides packet redirection and forwarding between the multiple types of networks available.

Thereby, the system according to the invention:

i) delivers greater bandwidth efficiency and network capacity by managing all data types over single and mixed networks by taking a protocol approach, thereby reducing the overhead created by extra connections established by applications in the wireless network (only one connection is required) and reducing the overhead of data being transmitted by reducing the required acknowledgements, sending only non-expired data and filtering out others, and not using inefficient TCP/IP spoofing and tunnelling techniques;
ii) increases overall quality of service by using an efficient protocol designed specifically for wireless networks and able to work with all data types (not just “background” data types). By tying directly into the TCP/IP command structure in the upper layer on a mobile device (or other networked device) a protocol is created; and by providing efficient prioritization, queuing, and scheduling of different data types a superior experience for applications such as VoIP, interactive gaming and streaming video is provided, along with email and corporate applications; and
iii) provides better network reporting and an integration strategy for carriers supporting multiple networks (mixed networks). As there is a client component within the system, a carrier can now observe their network end-to-end, treating the mobile device like a network element, enabling the carrier to support stronger Service Level Agreements (SLAs) and service quality assurance. Furthermore, the information about network and application status and performance is included as part of the same protocol which delivers the data and therefore obviates the need for extra transactions or scheduled tests to determine the status and performance of the network. Also, the carrier can observe what is on the client's device, including software and mobile device configurations, thereby allowing the carrier to address service issues in a timely fashion, reducing both costs and customer frustration. As the network information is transmitted to a server component, as part of the data protocol delivery, the carrier can receive extensive reports on network status, bringing full visibility of the network to the carrier. The lower layer component of the system, according to the invention, on the mobile device enables seamless switching or simultaneous use of multiple network technologies (e.g. between cellular 2.5G/3G/4G, Wi-Fi and WiMAX) which could be based on usage policy, application type, and/or network policy. This allows the carrier to provide their customers multiple network choices, using the choice that best satisfies their user's requirements without having to concern themselves on how to use the networks, or when to switch to the networks without interrupting the user or the application. This also provides greater network efficiency for the carrier by allowing the carriers to use faster networks for backhaul transport, e.g. Wi-Fi for music downloads, and the more expensive cellular networks for email and other data applications.

A method of registering a mobile device with an access point is provided, comprising the steps of: said mobile device sending a pre-registration request to the access point; said access point requesting authentication of said mobile device from a server; said server authorizing said mobile device to access said access point; said access point recording an address of the mobile device in an pre-register table; and said access point sending a second address, a network address and a time to live to the mobile device. The mobile device stores said second address, said network address and said time-to-live within a database and the access point contains updateable firmware. A SNR is used by said mobile device to determine whether to roam to said access point.

A method for a mobile device to roam from a first access point to a second access point is provided, comprising the steps of: determining when the signal to noise ratio is increasing from said first access point and decreasing from said second access point; sending a registration request to said second access point; sending said registration request to an advance server; said advance server redirecting traffic to the mobile device through a destination IP associated with the mobile device; said advance server sending confirmation to the mobile device; and after the mobile device receives the confirmation from the advance server, redirecting traffic to said advance server.

A threshold is determined for a time in which said signal to noise ratio must be increasing from said second access point, and the mobile device registers with said second access point after said threshold has passed. Preferably, the mobile device has pre-registered with said second access point.

### BRIEF DESCRIPTION OF THE DRAWINGS

FIG. 1 is a block diagram, showing a mixed network;

FIG. 2 is a block diagram, showing a vertical view of a mixed wireless network;

FIG. 3 is a schematic diagram of a mobile device, according to the invention;

FIG. 4 is a block diagram, showing a client layer overview in a system according to the invention;

FIG. 5 is a block diagram thereof, showing the client position with respect to other protocols;

FIG. 6 is a flow diagram thereof, showing the management of incoming traffic to the application;

FIG. 7 is a schematic diagram thereof, showing the lower client architecture;

FIG. 8 is a schematic diagram thereof, showing the scheduler;

FIG. 9 is a schematic diagram thereof, showing the SNR teller;

FIG. 10 is a flow chart thereof, showing the pre-registration and discovery process; and

FIG. 11 is a table showing the DMP signalling structure;

FIG. 12 is a table showing a preferred embodiment of a DMP session; and

FIG. 13 is a tree showing the structure of a DMP packet.

### DETAILED DESCRIPTION OF THE INVENTION

### Definitions

In this document, the following terms will have the following meanings:

“advance server” means a server in communication with ICS, through which ICS accesses the network;
“far-host” means a destination networked device, such as a mobile device, a server, or a software application, in communication with a network which is the destination of a transmission;
“mixed network” means network using different communication protocols for different network nodes and network devices, and may include mobile devices, and may employ more than one type of wireless protocol for communication;
“network device” means a device capable of communicating with other network devices that forms part of a wired, wireless, or mixed network; and
“wireless device” or “mobile device” means a device for communicating with wired or wireless devices over a wireless or mixed network.

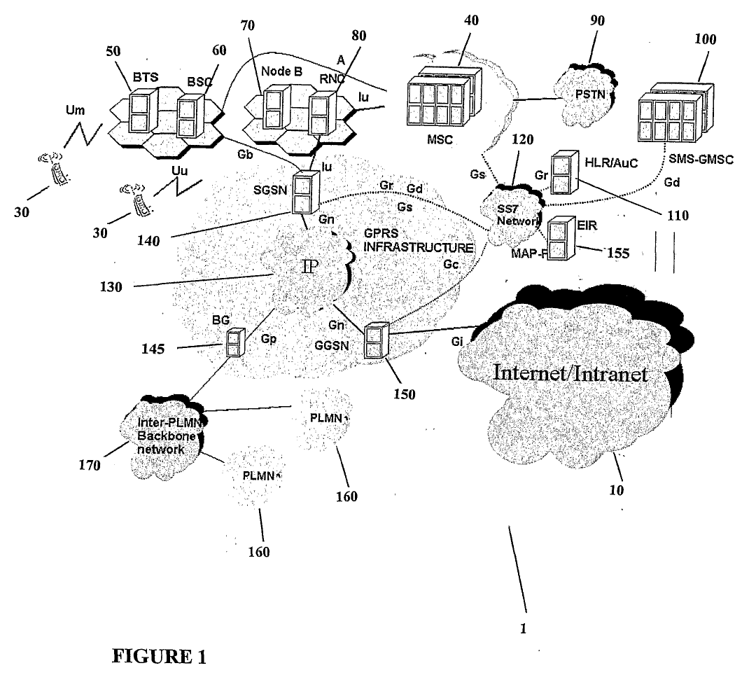

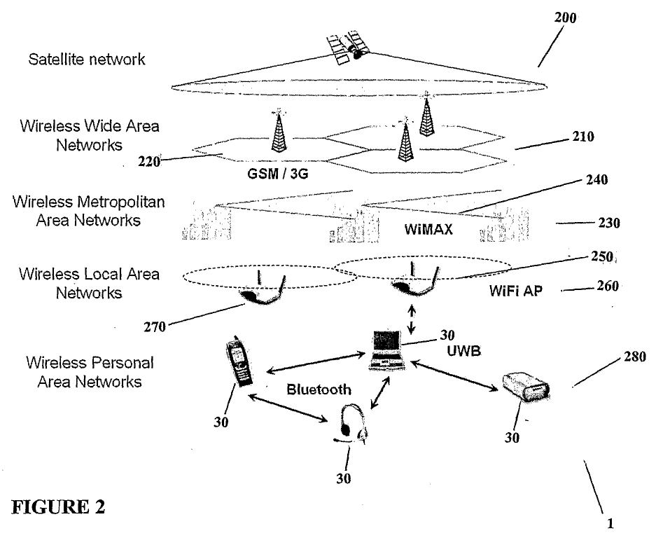

The system according to the invention is designed for use with mixed networks, examples of which are seen in FIGS. 1 and 2. While the illustrative example of the system and method according to the invention are described in terms of mixed networks, the invention could be used in a network in which only a single communication protocol is used.

FIG. 1 displays a representative mixed network environment 1, in which several networks communicate with each other, the Internet 10 and mobile devices 30. Elements of mixed network environment 1 include: mobile switching center (MSC) 40, base transceiver station (BTS) 50, base controller station (BCS) 60, network node 70, radio network controller (RNC) 80, public switch telephone network (PSTN) 90, Short Message Service-Global System for Mobile Communications center (SMS-GSMC) 100, Home Location Register/Authentication center (HLR/AuC) 110, Signaling System #7 (SS7) network 120, Equipment Identity Register (EIR) 155 using Mobile Application Part-Proxy (MAP-P), General Packet Radio Service (GPRS) network 130, Gateway GPRS Support Node 140, Breakout Gateway (BG) 145, Gateway GPRS Support Node (GGSN) 150, public land mobile network (PLMN) 160, and a inter-PLMN backbone network 170.

Mixed network environment 1 may have a wide variety of components and communication protocols used within. FIG. 1 shows a typical, but not representative network.

FIG. 2 displays an alternative viewpoint of a mixed wireless network environment 1 from a vertical view. Satellite network 200 provides the broadest coverage, and within satellite network 200 is wireless wide area network 210, in this case a GSM/3G network 220. Within wireless wide area network 210 is a wireless metropolitan area network 230, in this case a WiMAX network 240. Wireless local area networks 250 are within wireless metropolitan network 260, in this case WiFi network access points 270. Finally, within the wireless local area networks are wireless personal area networks 280 comprised of a plurality of network devices 30 using protocols to communicate such as Bluetooth and ultra wideband (UWB).

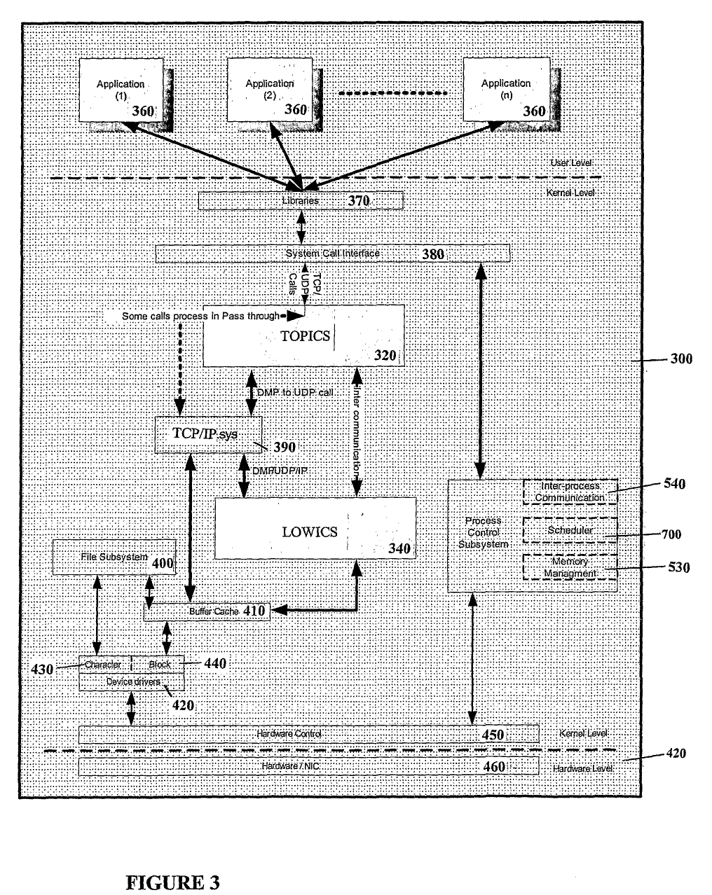

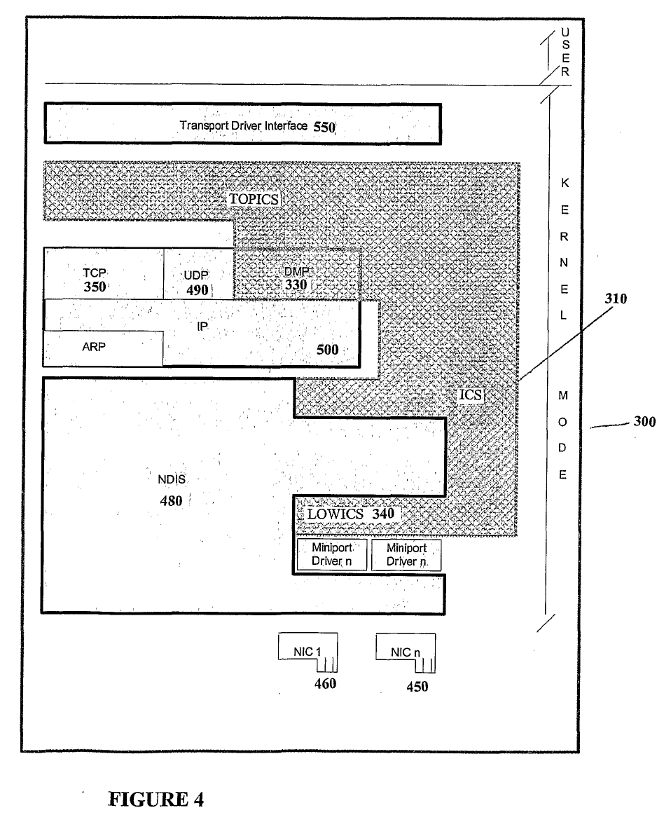

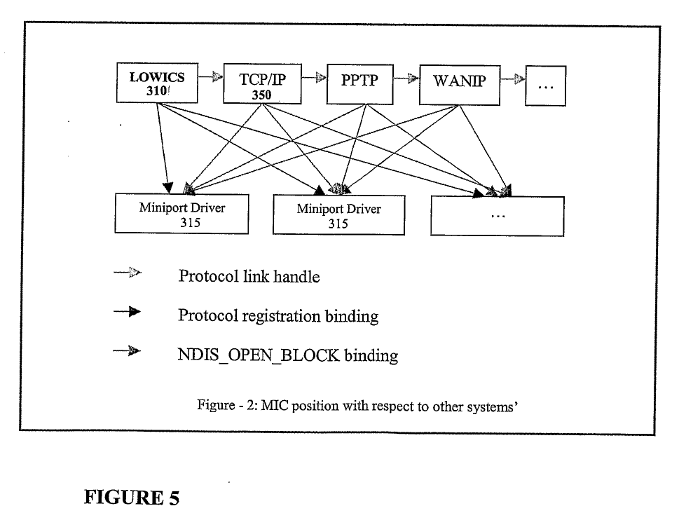

FIGS. 3 and 4 show schematics of a mobile device 30 incorporating the system according to the invention. FIG. 3 displays an overview of such a mobile device 30, and FIG. 4 displays the details of the kernal layer 300 and the relationship between the intelligent client system according to the invention and the operating system (OS) of the mobile device.

The traffic management system is stored on the mobile device as a series of drivers interfacing with standard OS libraries and function calls, as seen in FIGS. 3 and 4. The traffic management system is an intelligent client system (“ICS”) 310, which is comprised of three main components:
1. an upper layer, TOPICS 320;
2. a Dynamic Multimedia Protocol (“DMP”) 330 used as a transport layer protocol; and
3. a lower layer, LOWICS 340.

The client ICS 310 is at the same level as TCP 350 but extends to the data link layer (miniport drivers 315), as shown in FIG. 5. FIG. 5 illustrates the relationship between LOWICS 310 and the other protocols in the OS. LOWICS 310 resides as a protocol within the OS, but no other application or layers except for TOPICS 320 call LOWICS 310 yet LOWICS 310 intercepts the calls that arrive for other protocols e.g. TCP/IP 350. The protocols are related to each other in a chain format with respect to their hierarchy within the OS. Each protocol points to its next protocol in the chain and binds itself to the available network drivers, referred to as miniport drivers 315. LOWICS 310 therefore is loaded after all other protocols have been loaded and then points to the first protocol entry in chain, TCP/IP 350, and registers and binds to the available network drivers, miniport driver 315. In this fashion LOWICS 310 is capable of intercepting any packet leaving the IP layer to the MAC layer and therefore applies policy and scheduling to the packet in LOWICS layer 310.

Other components of mobile device 30, as seen in FIG. 3, include libraries 370, system call interface 380, TCP/IP.sys file 390, file subsystem 400, buffer cache 410, device drivers 420, character 430, block 440, hardware control 450, and hardware/NIC 460 at hardware level 470. The kernal level 300 also includes process control subsystem 510, which includes scheduler 700, memory manager 530 and inter-process communicator 540.

### TOPICS Layer 320

The TOPICS layer 320's main responsibility is to interface with calls from applications 360. TOPICS 320 maintains all application (requester) information, including socket information, device and file object information, and their interface including expected maximum transmission unit (MTU), buffer size, receive interface, expected receive message format, timeout, etc. TOPICS layer 320 maintains records regarding the application 360's predicted behaviour. As seen in FIG. 4, other components of mobile device 30's OS include: Network Driver Interface Specification (NDIS) interface 480, UDP interface 490, IP interface 500, and ARP interface 510. Transport driver interface 550 is between TOPICS 320 and applications 360.

TOPICS layer 320 also communicates with lower layer, LOWICS 340, to inform LOWICS 340 of the types of outgoing traffic, referred to herein as “Pre-Channel Transmission”. LOWICS layer 320 then passes the requester's message to DMP 330. TOPICS 320 includes TOPICS-DMP assembly worker (not shown), for assembling packets; and TOPICS interface for communicating with applications 360.

### Outgoing Traffic

The following is the transaction sequence for outgoing packets sent by an application 360 by the mobile device 30 through ICS 310 to a far-host:

1. The application 360's protocol is identified by TOPICS 320; by using the application name, the communication port, and/or scanning the header information of the first two user application buffers which requested the connection. The extracted information is verified by TOPICS 320 by comparing the extracted information against the application ID and/or signature and/or application catalogue ID, stored on the device. TOPICS also examines and determines the type of the transport layer protocol that application 360 has requested;
2. A response to the requester (application 360) is sent by TOPICS 320 to the application 360 for the related task, depending on whether the request (e.g. a request for creating a TCP socket and/or connecting to certain host), was successful or failed;
3. TOPICS 320 then creates and maintains an application book-keeping data structure about the application 360 and socket information, which is used for forwarding the response from the far-host to appropriate application 360;
4. LOWICS 340 is notified by TOPICS 320 of the appropriate outgoing traffic type;
5. TOPICS then passes the application 360 data to the DMP sub-module to build the corresponding DMP request protocol, based on the type of application, and the DMP packet is built (as described below);
6. The DMP packet is passed to UDP 190 and then to IP 500 layer;
7. LOWICS 340 receives the IP/UDP/DMP packet from IP 500 layer; and
8. The IP/UDP/DMP packet is scheduled and passed to the appropriate network interface card (NIC) 460, to be transmitted to far-host through an advance server.

### Incoming Traffic

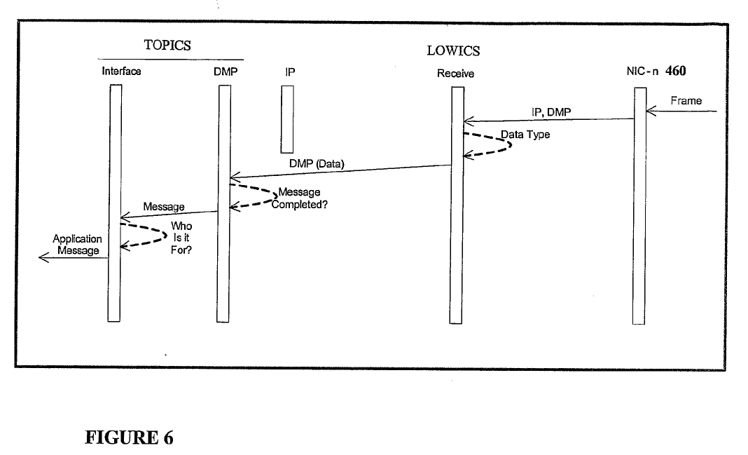

The process by which ICS 310 receives packets for mobile device 30 is shown in FIG. 6, and is as follows:

1. a DMP packet is received by a NIC 460;
2. LOWICS 340 separates the IP header from the DMP packet;
3. the type of DMP is identified through the DMP header and by LOWICS 340 receiver module to determine if local jitter handling is needed;
4. if the DMP contains data of any type other than real-time, the DMP packet is passed through a direct call to TOPICS DMP assembly worker (not shown), which is a component within the DMP module, (so the packet does not need to go through the IP layer 500);
5. the TOPICS-DMP assembly worker module assembles the packet to build a message, and when the message is complete it is passed to the TOPICS-Interface 530;
6. the TOPICS-Interface 530 determines, through its application book-keeping data structure, the appropriate application 360 which should be the message recipient; and
7. the TOPICS-Interface passes the message to the application 360 through a standard OS call.

### DMP (Dynamic Multimedia Protocol):

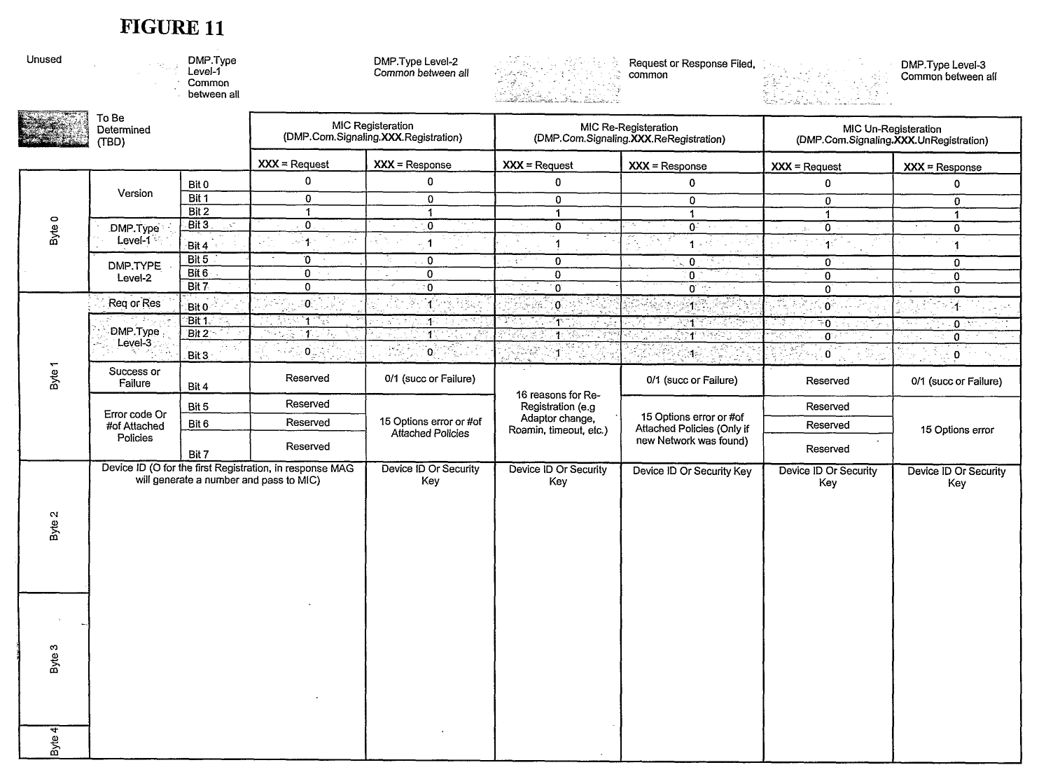

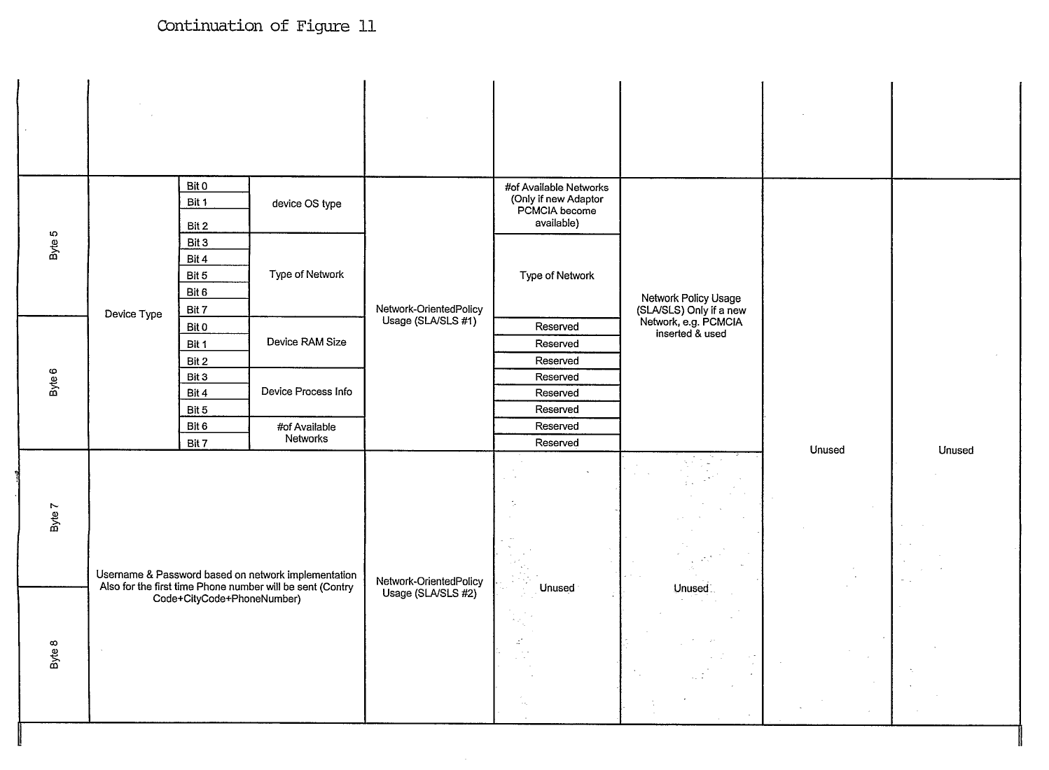

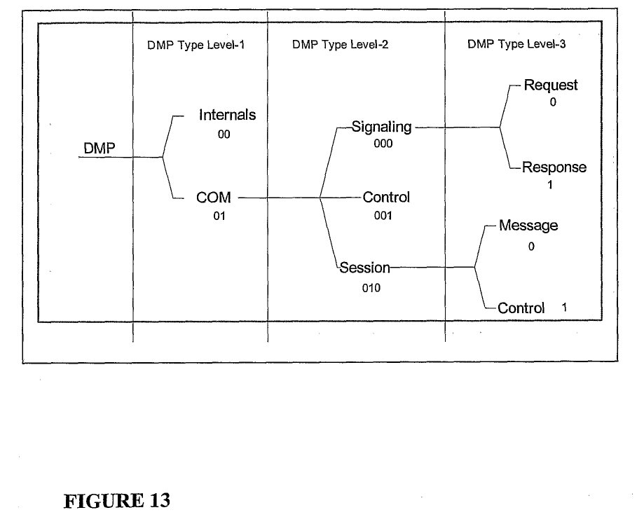

DMP 330 is a protocol capable of carrying any type of data. DMP 330 dynamically adapts itself as necessary, for example for varying acknowledgment requirements and best packet sizes. DMP 330 shares some of the characteristics of UDP and also some of the characteristics of TCP, however, DMP carries any type of data while meeting each data type's requirements over any type of wireless link through its dynamic header bits, as shown in FIGS. 11, 12 and 13. DMP 330 uses UDP/IP layer 500 as the transport and network layer protocol. DMP 330 preferably works with both IPv4 and IPv6, and provides the standard interface for applications and a standard interface to UDP/IP layer 500. FIG. 13 illustrates the branching of DMP. As shown in FIG. 13 there are three levels in DMP that are distinguished by header bits.

1. DMP Layer 1: contains “DMP Internals” and “DMP Communication” (DMP COM). DMP Internals: Used for internal communications among components within single sub-system, e.g. communications between TOPICS 320 and LOWICS 340.

2. DMP Layer 2 is a branch off DMP COM and it carries three types of messages, Signalling, Control and Session. DMP Signalling: Used for communication between two sub-systems, namely:
a. DMP Control:
   Activities between LOWICS←→software in an AP, and software in an AP←→server for control proposes. For example, the server notifies ICS to change its packet size, or ICS provides the server with network status information or logs. Also DMP Control is used for sending control message to ICS to control the functionality of ICS.

3. DMP Layer 3, is a branch off DMP Signalling and DMP Session (each branch to two)
a. DMPComSignaling Request: Carries a signalling request such as Registration, Re-Registration, Un-Register and acknowledgments between TOPICS 320←→Advance Server
b. DMPComSignaling Response: Carries a response to the requested signal
c. DMPComSession Message: Carries the actual application data
d. DMPComSession Control: Carries application connection requests, such as socket connect, and/or control feedback information such as RTCP

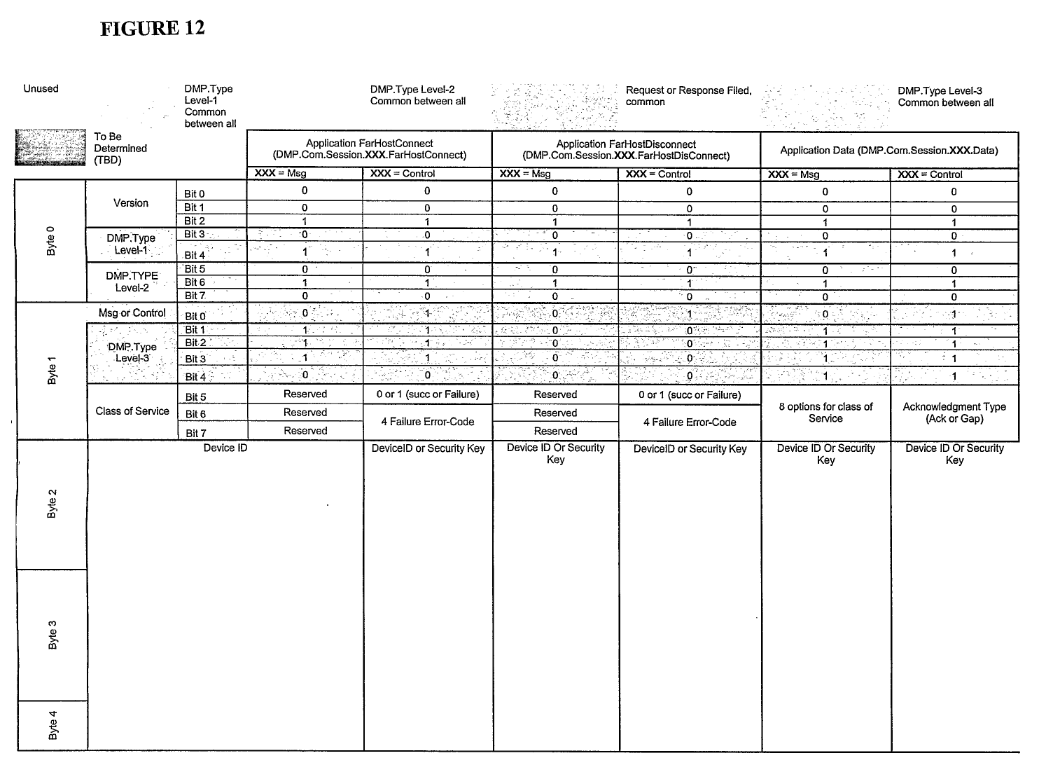

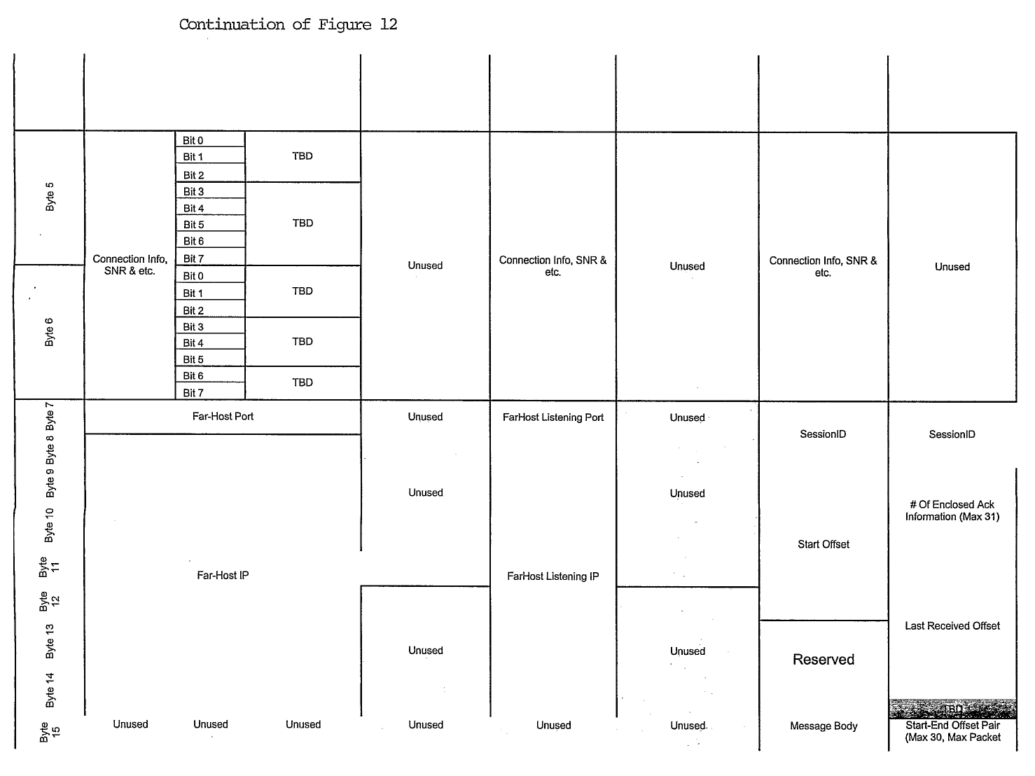

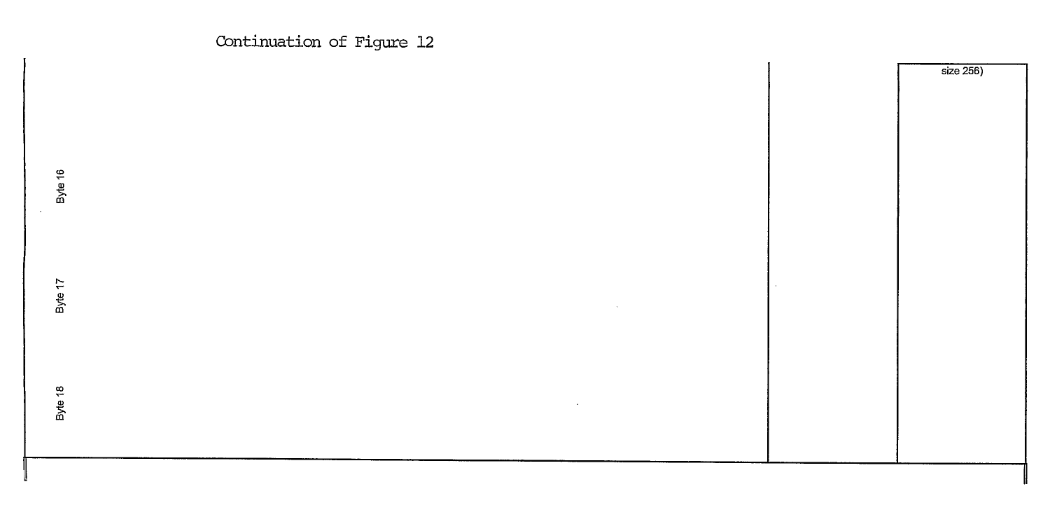

FIGS. 11 and 12 illustrate details of and embodiment of a DMP structure for both DMP Signalling and DMP Session according to the three layer structure, described above. Other embodiments of a DMP protocol may be used, including a subset of the features described herein and in the Figures.

### LOWICS Layer:

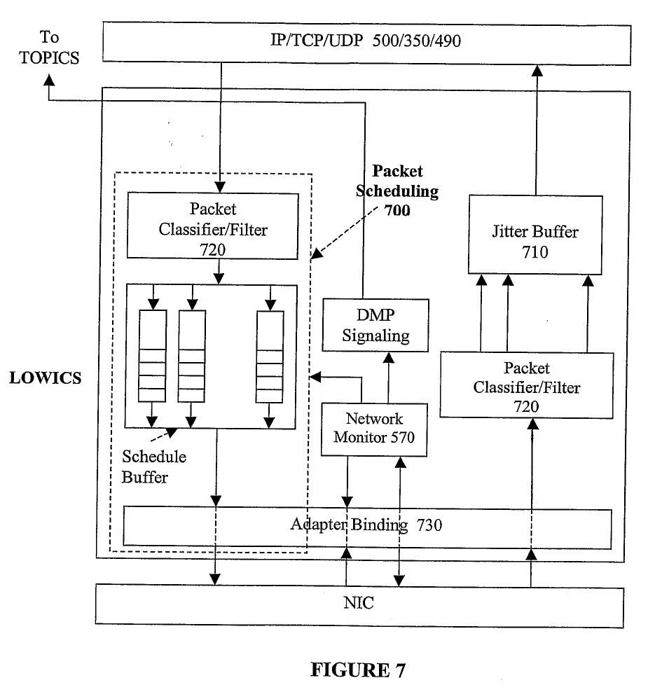

The LOWICS layer 340 includes four main sub-modules, each discussed below. The LOWICS layer 340 resides in the OS of mobile device 30 in three different formats as a layer, hooking (a method of inserting a layer into the operating system) and as a protocol. FIG. 7 illustrates the overview of LOWICS 340 with respect to the OS and its internal components. As shown in FIG. 7, the modules include:

1. Scheduler system 700;

### 2. Network Monitor 570;

(a) Neighbourhood Discovery;
(b) Signal to Noise Ratio Teller;
(c) Packet forwarding;

### 3. Local Jitter Buffer 710; and

### 4. Packet Classifier 720.

### LOWICS—Scheduler:

The system according to the invention has the capability of distinguishing between different types of data received or sent by mobile device 30 (or other networked device) and can identify a mobile traffic model for such data. Each different data type has its own requirements, including end-to-end transmission control, and latency sensitive real-time requirements. An objective of the system according to the invention is to meet as many requirements as possible for these different data types. Therefore, the system differentiates the data and handles the packets with the objectives of: controlling traffic over the wireless link, maintaining loads, increasing the capacity of the network, and providing bandwidth improvements.

In order to identify the data type requirements three parameters are identified and considered:

i) The maximum error rate: interpreted as the acceptable value used to identify the type of error detection for the physical channel as well as transport layer protocol.

ii) The minimum throughput: interpreted as the priority of delivery, as different types of packets have different time requirements for delivery. For some types of data (voice, streaming video, etc.), transmission of the packet after time expiration simply becomes part of network overhead, so data of such types that have expired with respect to time are not delivered.

iii) The maximum delay: interpreted as the maximum number of retransmission attempts for that data type and the time between retransmission attempts.

To manage the diverse traffic types, the system calculates a “life time”. This life time is the period of time in which a decision is made for all packets of a particular application. For example, a group of packets could belong to a message application. A “session” is a life time in which the packets belong to and exist in that life time of a single application. A life time can be a deterministic type or a random distribution inter-arrival type. Different classes of services, namely background, interactive, streaming and conversational are used to narrow the traffic classes to categories of: Voice, Video, Audio and Data, so that the characteristics and requirements of each data type can be outlined and a mobile traffic model identified as in following Tables 1 and 2.

TABLE 1
Traffic type and sensitivity

| | | | Inter-Arrival | | | |
|---|---|---|---|---|---|---|
| Traffic | | | Generation | | Traffic | |
| Type | Latency | Error | Rate | Packet Size | Model | Equation |
| Voice | HighlySensitive | LowSensitivity | Fix | Fix | ParetoDistribution | $F ( p ) = 1 - {( \frac{S}{P} )}^{α} , p \geq S$ |
| Data | LowSensitivity | HighlySensitivity | Highly Variable | Highly Variable | ExponentialDistribution | $F ( t ) = 1 - {e}^{- \frac{t}{T}} , t \geq 0$ |
| Video | Highly | Low | Fix | Highly Variable | | |
| | Sensitive | Sensitivity | | (depending on | | |
| | | | | codec) | | |
| Audio | Highly | Low | Fix | Highly Variable | | |
| | Sensitive | Sensitivity | | (depending on | | |
| | | | | codec) | | |

F(P): Pareto distribution Function,
S: minimum packet size,
P: Packet Size
F(T): Random distribution Function,
t: time,
T: expected value of the inter-arrival time t

As an example, Voice over IP (VoIP) is highly sensitive to the latency while it is not sensitive to error, as a user can always ask for the other party to repeat. However, the data's rate of arrival to TOPICS 320 is fixed and its packet size is fixed. Looking at the traffic that VoIP generates, it follows the model of Pareto Distribution. Data, however, such as Internet Explorer typically communicates, is very low sensitive for latency while highly sensitive to error, e.g. receiving corrupted banking information. The arrival rate of the packets (or its generation rate) for Data is variable and unpredictable, as it is generated and arrives in bursts, and the traffic type that it generates follows the exponential distribution. This information of the type of traffic model allows scheduler system 700 to make scheduling decisions based on the type of traffic model expected and whether the available networks have the capability of delivering the traffic or not. For example, in a mixed network, where the mobile user is on 2.5 Generation network, such as GPRS, using VoIP application is not appropriate since this type of network doesn't have the capability of delivering the type of traffic.

TABLE 2
Service Class description

| Service | | Bit Error | # of | Value of |
|---|---|---|---|---|
| Class | Priority | Rate (BER) | Transmission | T, S and α |
| Voice | 6 | 10⁻³ | 3 | T = 0.001 s |
| | | | | S = 256 bits |
| Data | 2 | 10⁻⁵ | 8 | T = 0.01 s |
| | | | | S = 8000 bits, |
| | | | | α = 1.03 |
| Media | 4 | 10⁻⁴ | 3 | T = 0.005 s |
| (Video/Audio) | | | | S = 1280 bits, |
| | | | | α = 1.03 |

As illustrated in table 2 and based on table 1; the type of traffic is classified with respect to their priority in which they have to be serviced, delivered and transferred to the network, and tolerated Bit Error Rate (BER) such that if the error in packet was less than the BER, then there is no need to request for retransmitting the data and also determine how many times the data can be retransmitted before the data expires (based on its time to live). For example a VoIP packet can be retransmitted (if un-arrived) three times using fast retransmission before the packet's time to live expires, which is 250 milliseconds end-to-end (as set in VoIP standards). Using this method the values of T (the expected value of inter-arrival time t), S (the minimum packet size), and α (a constant value) can be inserted into either the Pareto or Exponential Distribution function shown in Table 1 for scheduler system 700 to make a decision for packet scheduling.

The different classes of service, include the Interactive class of service, which refers to the type of application/traffic which is a request/response oriented and it requires users interaction. An example of this application is Internet Explorer where the request sent and a response received. The Background class of service, refers to the type of applications that it runs in background and does a burst type of transaction. Email is an example of this type of application, as there is no need for the user interaction the email runs in the background and receives the information. A Streaming class of service, refers to the type of application where there is a request for receiving a media, not necessary in real-time, similar to video or audio. Real-time class of service, also referred to as conversational, are the class of services that are very time-sensitive. They typically have a fixed time to live set by industry. As an example a voice over IP packet has only a 250 millisecond acceptable delay, if it received after that the packet will not be processed by the receiver. Examples of this type of application/service are Voice Over IP (VOIP), and video telephony.

Scheduler system 700 completes three main tasks, namely: queue managing; scheduling; and the channel SNR teller.

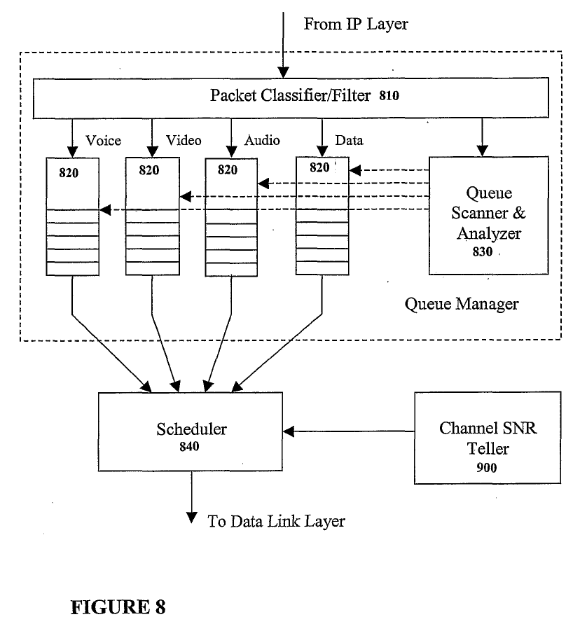

As seen in FIG. 8, queue manager 800 in scheduler system 700 includes packet classifier 810, multiple queues 820 dedicated to different types of data, and queue tracker 830 (a queue scanner and analyzer) that reports on the traffic stored within each queue and the number of expired packets and delayed packets within each queue. Scheduler 840 acts as the decision maker between queue manager 800 and data link layer 850. Scheduler 840 examines the contents of queue manager 800 and data link 850 and makes decisions. Scheduler 840 also manages data traffic between the network layer and the data link layer 850. This process isolates the high-layer application or the network layer from direct interaction with the lower layer. However, these layers are mutually aware of each other.

In practice, IP layer 500 passes packets to packet classifier 810; packet classifier 810 examines the type of packet and associates an appropriate time for the packet, based on the type of packet, and then inserts that packet into appropriate queue 820. In a preferred embodiment of the system, the queues are for four distinct data types as previously described, namely: voice, video, audio and data. As a wireless network grows other types of data with different characteristics may be included. A challenge posed by queue 820 is the need for a module to monitor the queue, which normally adds delay to transmission scheduling. For this reason, each packet inserted in the buffer of queue 820 is an active record, resulting in the creation of packets of type timer. The expiration period of these packets varies for each timer as the timer packets are also typed (as voice, video, audio, or data timer). If the packet does not arrive at scheduler 840 before expiry of the timer the packet exits queue 820 and notifies queue tracker 830 of its expiry. Queue tracker 830 reports to scheduler 840 the number of expired packets, thereby notifying the scheduler 840 of the traffic congestion at each queue 820. Scheduler 840 makes a judgment as to which queue 820 should receive service first based on the time sensitivity of the data type within the queue 820. Scheduler 840 may also be deployed on a server to schedule downlink data traffic to multiple mobile devices and different data traffic within a mobile device.

### LOWICS—Network Status Monitor:

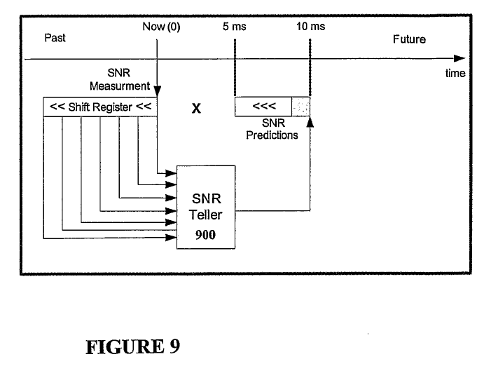

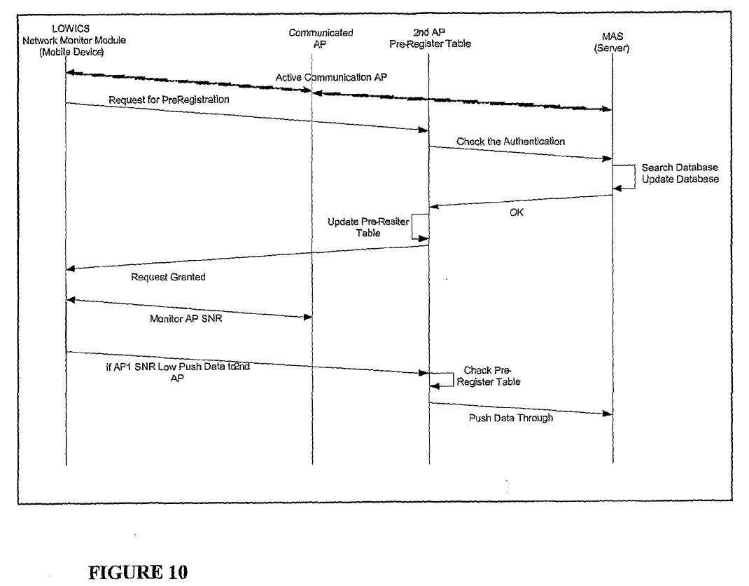

The SNR teller 900, as seen in FIG. 9, is part of the network status monitor module. SNR teller predicts the near future Signal to Noise Ratio, in a time frame between the present (0) to the next 10 ms. The objective of this component is to be able to detect the expected signal-to-interference-plus-noise-ratio (SINR) value. Generally speaking SINR is the ratio of Signal Strength to the background noise ratio. The link rate depends on the SINR at the user's location. SINR can vary significantly within a cell. This variation is an inherent characteristic of all wireless systems and occurs primarily because of variations in RF propagation loss, building penetration loss, fading effects, and co-channel interference. As a result, the link rate experienced by a user may depend on his/her position within a cell, just as in the case of DSL.

Based on the support from Network Monitor 520, SNR values will be monitored. The objective of SNR teller system is to receive the monitored SNR value and by looking at these values in the past 5 ms to present being able to calculate and estimate the expected value of the SNR value is in the next 5 to 10 millisecond. This resulted expected value will be used by the network monitor status module to make decision of when to switch the network, from one type to another (e.g. WiFi to cellular) and also used by the scheduler system to take this parameter into consideration for its scheduling decision making.

### LOWICS—Neighbourhood Discovery

Neighbourhood discovery is a method, according to the invention, that reduces the time required when moving from one access point (“AP”) to another over a wireless link (known as “roaming”), for example, a mobile device user moving in an airport. There are several different areas of research in eliminating this delay especially in the RF layer (Layer 1). In a preferred embodiment a RF level latency reduction layer 3.5 solution is used. For connection-oriented applications (for example, those that are TCP/IP based) the latency to transfer the communications and connection from one AP to another could result in the retransmission of data and reestablishment of TCP after receiving a new IP from a new domain (in case of an intra domain move). For time-sensitive applications, this results in additional delay caused by the movement from one AP or domain to another.

In a preferred embodiment, a Layer 3.5 solution is used, which is a superset of Layer 2 roaming. In this embodiment, a layer above the Media Access Control (MAC) Layer and below the IP layer 500 monitors the AP(s) and domains, handles the packet forwarding between different AP's, while also shielding the higher layer of any changes. This solution requires Layer 2 roaming first but eliminates the extra delay of authentication and roaming applications to the new AP.

To achieve a preferred method of roaming, three main areas are considered:
a) Neighbourhood discovery;
b) Pre-registration; and
c) Packet forwarding.

In a preferred embodiment, a network status data module 570 located within LOWICS 340 provides network status data and neighbourhood discovery. In this embodiment LOWICS 340 has a single virtual adapter interface to the IP layer 500 but may bind itself to as many NIC 460 as are available. Network status monitor 570 monitors the collected AP information from a Wi-Fi card, including the AP name, MAC, Signal Strength, Noise Strength, and Signal to Noise Ratio. Network status monitor detects the next closest AP by receiving information from SNR Teller 900, which calculates the SNR for a period of time starting from past to future within a small time frame. SNR Teller 900 then sends pre-registration information to network status monitor 570 with the “Backup AP” that it has decided to be moved to. Therefore, the AP is located before a decision is made to roam.

In a preferred embodiment, the AP contains updateable firmware. Usually the AP firmware contains an IP layer protocol structure, including a routing table, a MAC address update table, DNS, and other functionality. This firmware may be updated by adding a pre-register table. After identifying the AP the network status data module then sends a pre-registration request to the AP. The AP forwards the request to an advance server (“AS”) and asks for authentication for the mobile device 30. The AS will check the authentication of the mobile device 30 against its database and send the authorization to the AP. The AP then records the MAC address of mobile device 30 in the AP's pre-register table. The AP also sends its own MAC address, network address and a time-to-live to the mobile device 30. When the network status data module 570 receives this information it stores for use for the next roam. The time-to-live tells the network status monitor 570 of the period of time the AP will keep the information in its pre-register table. If this time expires the network status monitor 570 should look for another round of pre-registration request. In the meantime, the network status monitor 570 will continuously look at the SNR to determine if the backup AP is the appropriate AP to roam to next.

In case the backup AP SNR degrades then the network monitor looks at finding and pre-registering with a new AP. The network status data module 570 in LOWICS 340 continuously monitors the network status and SNR. It is important that balance be maintained between fast roaming times and client stability. As an example, it is normal for an AP's signal strength to reduce as a function of its environment and frequency, therefore, such an occurrence should not be considered for a roam, or “handoff”, as it could be an instant occurrence of the AP signal strength, and not the normal signal strength for such AP. To accomplish this, a timeframe threshold is created for the stability of the signal before roaming to that AP. A preferred threshold should be between 5 and 10 ms, but longer or shorter periods could be used.

The SNR should decrease in an active AP and increase in the back up AP before roaming occurs. To move from one AP or domain to another, network status monitor 570 first sends an update registration (Re-Registration) to the AS through the backup AP. As the backup AP already has the information in its pre-registered table, it just pushes the request to the AS immediately. This notifies the AS of the change of IP so the AS will start redirecting downlink traffic to the mobile device 30 through the new destination IP of the mobile device. After the mobile device 30 receives the confirmation from the AS, mobile device 30 redirects the uplink traffic. During this time mobile device 30 does not send any uplink traffic to the AS until it receives the confirmation. This method reduces the packet loss during the roaming, reduces the roaming duration as the information already exists in the pre-registered table at the AP, and the change to the mobile device IP is completely transparent to the applications on both the mobile device and the far-end host application on the Internet. The latter sees the AS as the mobile device.

FIG. 10 displays an overview sequence of events in pre-registration and neighbourhood discovery.

### LOWICS—Local Jitter Handling:

The LOWICS 340 local jitter handler 710 handles received real-time data types. Its main responsibility is to handle the jitter on VoIP and real-time video based on the network status and information received. This eliminates the need for using RTCP, which creates high network overhead. To achieve this, a buffer agent examines the Type of Content (ToC) within DMP and decides whether to deliver the DMP to a higher layer or keep it in the buffer module. Each data packet inserted into a buffer is attached to a timer. As the timer expires the data packet will exit the buffer queue in the higher layer. This makes the individual rows of the buffer an active agent that “watch” the buffer's state. This reduces a need for an agent to track what has to be removed from the buffer and what does not and therefore reduces the buffer delay. The jitter buffer is in the lower layer as decisions are made based on real-time network information instead of on the feedback mechanism provided by RTCP. The feedback mechanism is not very efficient, as the frequency of incoming feedback cannot be adjusted for efficiency for wireless traffic while also providing sufficient and timely information to reduce jitter. Using the above described process, jitter may be reduced by 20-30%.

### Network Policy

The method and system according to the invention can also control a network device based on the requirements of the network policy. In such a case, the network policy must be created, and transmitted to the network device for storage, such as a mobile device, when the network device requests registration.

When an application is attempting to access the network, the network policy usage will be checked, and TOPICS and LOWICS will provide network access to the application according to the policy. During the transactions between the network device and network server, at any time if the network policy is changed at the database in the advance server the change will be pushed to the network device in a form of “Policy Push” command.

The two tables below describe, in a preferred embodiment, the policy parameters that will be pushed to the networked device at the registration time. Table 3 describes the policy parameters; Table 4 describes a “Class of Service” data structure.

TABLE 3

| PARAMETER | DESCRIPTION |
|---|---|
| User Class | Identifies the priority of users in using network. This parameter is usually refer to |
| | as Gold, Silver and Bronze. |
| Class of Service | Identifies the type of service, Background, Interactive, Streaming, Conversational |
| Priority of Service | This can be High, Medium and Low variable or a numerical value of 0 to 10; |
| | where 10 is the highest priority. Note that up & downlink bandwidth could still |
| | differentiate services sharing the same priority. |
| Uplink Bandwidth | The Bandwidth used for the specific class of service in Uplink channel |
| Uplink Data Rate | Average and Peak Data Rate for the Uplink channel |
| Delay | Maximum tolerable delay, this is only enforceable within the QoS scheduling of |
| | LOWICS for maximum delay that packet can stay in Queue before being |
| | delivered to the MAC layer |
| Downlink Data Rate | The policy used in Downlink (from MAG to ICS) for transferring data for this |
| | class of service. This will help ICS estimate the expected delay of arrival of the |
| | packets from MAG |
| Uplink Total Data Transmission | A parameter used to keep track of the total data transmission per month for that |
| | class of service in Uplink channel. The time will be reset and pushed to the ICS |
| | from MAG side. This could be calculated to exclude the duplicate/lost packets |
| | and even headers from the customer's actual payload data |
| Offset time | The time that total data transmission will be reset for usage and accounting |
| | purposes. This is offset time will block user to send data over the uplink when |
| | they reach maximum transmission on uplink |
| Network Type | Identifies the type of network (Preferred type, or the only type) that can be used |
| | for that service |
| Time of Use | Whether this person can use this service at all the time or only certain time (e.g. |
| | slow hours or peak hours or always) |

TABLE 4

| PARAMETER | DESCRIPTION |
|---|---|
| User Class | Identifies the priority of users in using network. This parameter is usually refer to |
| | as Gold, Silver and Bronze. |
| Application Name | Name of application using network |
| Destination IP | The IP of the far host |
| Destination URL | Far-host URL (it could be exchangeable with Destination IP) |
| Access | A Union that contains Access information similar to class of Service structure. If |
| | the Uplink & Downlink Bandwidth value is zero then this means no access. |
| Uplink Bandwidth | The Bandwidth used for the specific class of service in Uplink channel |
| Uplink Data Rate | Average and Peak Data Rate for the Uplink channel |
| Delay | Maximum tolerable delay, this is only enforceable within the QoS scheduling of |
| | LOWICS for maximum delay that packet can stay in Queue before being |
| | delivered to the MAC layer |
| Downlink Data Rate | The policy used in Downlink (from MAG to ICS) for transferring data for this |
| | class of service. This will help ICS estimate the expected delay of arrival of the |
| | packets from MAG |
| Uplink Total Data Transmission | A parameter used to keep track of the total data transmission per month for that |
| | class of service in Uplink channel. The time will be reset and pushed to the ICS |
| | from MAG side. This could be calculated to exclude the duplicate/lost packets |
| | and even headers from the customer's actual payload data |
| Offset time | The time that total data transmission will be reset for usage and accounting |
| | purposes. This is offset time will block user to send data over the uplink when |
| | they reach maximum transmission on uplink |
| Network Type | Identifies the type of network (Preferred type, or the only type) that can be used |
| | for that service |
| Time of Use | Whether this person can use this service at all the time or only certain time (e.g. |
| | slow hours or peak hours or always) |

### Network Performance

The method and system according to the invention can provide service performance and status information to a carrier for any application over any types of network and without a need for creating extra transactions over the network. To do this, the network device stores an acceptable performance threshold parameter per application on the device. As the application data is carried to the advance server, the network device stores information about the type of network used per packet, the signal to noise ratio parameter on each packet, packets lost, duplicate, retransmissions and the total time needed to deliver application message and receive response information. This information is stored within a database in network status monitor 520. If any of the parameters exceed the threshold set in either the database, local in the network device, or calculated based on certain rules (such as the network policy), the an alert is generated and sent to the advance server.

### Determining Type of Application Data

The system and method according to the invention can be used to determine the type of application data on a client device, such as a mobile device, without changing the application. This is done when ICS receives an application request by intercepting the call. ICS then identifies the application name, and/or the port used to send the message, and/or the header information (which is part of the first two application message buffer sent for the request for connection). This extracted information, such as VoIP, Video, email, Internet explorer; is used to create a corresponding tag, such as Real-time, Streaming, Background, Interactive, and the packet is accordingly tagged.

The above described system and method can be implemented as a series of instructions stored on computer readable memory within a networked device, such as within RAM, or on computer readable storage medium. The method and system may be expressed as a series of instructions present in a carrier wave embodying a computer data signal to communicate the instructions to a networked device or server, which when executed by a processor within the mobile device or server, carry out the method.

The above method and system, while described in the context of a wireless or mixed network, would also have application in wired networks, in cases where the wired network device is “smart” and able to identify and process incoming packets.

Although the particular preferred embodiments of the invention have been disclosed in detail for illustrative purposes, it will be recognized that variations or modifications of the disclosed apparatus lie within the scope of the present invention.

The invention claimed is:

1. A method of registering a mobile device with an access point, comprising the steps of:
(a) said mobile device sending a pre-registration request to the access point;
(b) said access point requesting authentication of said mobile device from a server;
(c) said server authorizing said mobile device to access said access point;
(d) said access point recording an address of the mobile device in an pre-register table; and
(e) said access point sending a second address, a network address and a time to live to the mobile device.

2. The method of claim 1 wherein, said mobile device stores said second address, said network address and said time-to-live within a database.

3. The method of claim 2 wherein said access point contains updateable firmware.

4. The method of claim 3 wherein a SNR is used by said mobile device to determine whether to roam to said access point.

5. A method for a mobile device to roam from a first access point to a second access point, comprising the steps of:
(a) determining when the signal to noise ratio is increasing from said first access point and decreasing from said second access point;
(b) sending a registration request to said second access point;
(c) sending said registration request to an advance server;
(d) said advance server redirecting traffic to the mobile device through a destination IP associated with the mobile device;
(e) said advance server sending confirmation to the mobile device;
(e) after the mobile device receives the confirmation from the advance server, redirecting traffic to said advance server.

6. The method of claim 5, wherein a threshold is determined for a time in which said signal to noise ratio must be increasing from said second access point.

7. The method of claim 6, wherein said mobile device registers with said second access point after said threshold has passed.

8. The method of claim 7 wherein said mobile device pre-registers with said second access point.
